(19) United States
(12) Patent Application Publication
(10) Pub. No.: US 2025/0201445 A1
(43) Pub. Date: Jun. 19, 2025

(54) COMPOSITE ELECTRIC WIRE AND METHOD FOR MANUFACTURING COMPOSITE ELECTRIC WIRE

(71) Applicant: Sumitomo Wiring Systems, Ltd., Yokkaichi-Shi (JP)

(72) Inventors: Taiki SHIKATA, Yokkaichi-Shi (JP); Hidetsugu KUBOTA, Yokkaichi-Shi (JP); Yukitoshi TERASAKA, Yokkaichi-Shi (JP); Megumi YAMAO, Yokkaichi-Shi (JP)

(73) Assignee: Sumitomo Wiring Systems, Ltd., Yokkaichi-Shi (JP)

(21) Appl. No.: 18/975,770

(22) Filed: Dec. 10, 2024

(30) Foreign Application Priority Data
Dec. 18, 2023 (JP) 2023-213092

(51) Int. Cl. H01B 7/40; B60R 16/02; H01B 7/00; H01B 7/36

(52) U.S. Cl. CPC H01B 7/40; H01B 7/0045; H01B 7/36; B60R 16/0215

(57) ABSTRACT

Provided is a composite electric wire capable of preventing twisting of an electric wire when attached to an attachment target. A composite electric wire includes a first electric wire, a second electric wire, a third electric wire, and an insulating covering that collectively covers the first electric wire, the second electric wire, and the third electric wire. The first electric wire, the second electric wire, and the third electric wire include exposed portions that are exposed due to protruding outside from an end portion of the insulating covering. A first reference line is provided at a portion in a peripheral direction of the insulating covering, and a second reference line is provided at a portion in a peripheral direction of the exposed portion of the first electric wire.

### CROSS-REFERENCE TO RELATED APPLICATIONS

This application claims priority of Japanese Patent Application No. JP 2023-213092 filed on Dec. 18, 2023, the contents of which are incorporated herein.

### TECHNICAL FIELD

The present disclosure relates to a composite electric wire and a method for manufacturing a composite electric wire.

### BACKGROUND

Conventionally, some composite electric wires include a plurality of electric wires and an insulating covering that collectively covers the plurality of electric wires (e.g., see JP 2005-158451A). Such a composite electric wire is attached to an attachment target such as a vehicle by means of, for example, an attachment member. For example, the attachment member is fixed to the insulating covering while covering the outer periphery of the insulating covering. The attachment member also has an attachment portion, such as a fitting portion, that protrudes radially outward from a portion in a peripheral direction of the insulating covering and is attached to an attachment target.

JP 2005-158451A is an example of related art.

### SUMMARY

Incidentally, the plurality of electric wires in the composite electric wire may have exposed portions that protrude outside from an end portion of the insulating covering. When the electric wires have exposed portions, there are cases where it is desirable to attach some of the exposed portions of the electric wires to the attachment target while attaching a part of the insulating covering to the attachment target. In such a case, if the attachment member fixed to the insulating covering and the attachment member fixed to the exposed portions of the electric wires are fixed carelessly, there is a risk that the attachment portions of the attachment members will face in different directions, which may cause the electric wires to become twisted when attached to the attachment target. Note that twisting of the electric wires can cause the electric wires to bend, which can lead to problems such as the electric wires colliding with other components.

An object of the present disclosure is to provide a composite electric wire capable of preventing twisting of the electric wires when attached to an attachment target, and a method for manufacturing the composite electric wire.

The composite electric wire of the present disclosure includes: a plurality of electric wires; and an insulating covering that collectively covers the plurality of electric wires, in which the plurality of electric wires include exposed portions that are exposed by protruding outside from an end portion of the insulating covering, a first reference mark is provided at a portion in a peripheral direction of the insulating covering, and a second reference mark is provided at a portion in a peripheral direction of the exposed portion of one of the plurality of electric wires.

According to the composite electric wire and the method for manufacturing the composite electric wire of the present disclosure, it is possible to prevent twisting of the electric wires when attached to an attachment target.

### BRIEF DESCRIPTION OF THE DRAWINGS

FIG. 1 is a schematic side view of a composite electric wire according to an embodiment.

FIG. 2 is a partial plan view of a composite electric wire according to an embodiment.

FIG. 3 is a cross-sectional view taken along line 3-3 in FIG. 2.

FIG. 4 is a schematic side view illustrating a method for manufacturing a composite electric wire according to an embodiment.

FIG. 5 is a schematic side view illustrating a method for manufacturing a composite electric wire according to an embodiment.

### DETAILED DESCRIPTION OF PREFERRED EMBODIMENTS

First, embodiments of the present disclosure will be listed and described.

In a first aspect, the composite electric wire of the present disclosure includes a plurality of electric wires; and an insulating covering that collectively covers the plurality of electric wires, in which the plurality of electric wires include exposed portions that are exposed by protruding outside from an end portion of the insulating covering, a first reference mark is provided at a portion in a peripheral direction of the insulating covering, and a second reference mark is provided at a portion in a peripheral direction of the exposed portion of one of the plurality of electric wires.

According to this configuration, the first reference mark is provided at a portion in the peripheral direction of the insulating covering, and the second reference mark is provided at a portion in the peripheral direction of the exposed portion of at least one of the plurality of electric wires, thereby making it possible to prevent twisting of the electric wire. For example, when a first attachment member, which is to be fixed to the insulating covering while a first attachment portion is attached to a first attachment target, is fixed to the insulating covering, the position in the peripheral direction of the first attachment portion is determined based on the first reference mark. When a second attachment member, which is to be fixed to the exposed portion of the electric wire while a second attachment portion is attached to a second attachment target, is fixed to the exposed portion, the position in the peripheral direction of the second attachment portion is determined based on the second reference mark. This makes it possible to prevent twisting of the electric wire when the composite electric wire is attached to the first attachment target and the second attachment target.

In a second aspect according to the first aspect, a first attachment member may be fixed to the insulating covering and the insulating covering may be attached to a first attachment target by a first attachment portion of the first attachment member, a second attachment member may be fixed to the exposed portion of the electric wire provided with the second reference mark and the exposed portion may be attached to a second attachment target by a second attachment portion of the second attachment member, the first reference mark may be a first reference line provided continuously from a non-twistable range adjacent to the end portion of the insulating covering, to a fixing location of the first attachment member, and the second reference mark may be a second reference line provided continuously from a non-twistable range adjacent to the end portion of the insulating covering, to a fixing location of the second attachment member.

According to this configuration, the first reference mark is a first reference line that is continuous from the non-twistable range adjacent to the end portion of the insulating covering to the fixing location of the first attachment member, and the second reference mark is a second reference line that is continuous from the non-twistable range adjacent to the end portion of the insulating covering to the fixing location of the second attachment member, thereby preventing the electric wire from twisting one revolution, for example. That is, if, for example, the second reference mark is provided at only the fixing location of the second attachment member and that fixing location is far from the end portion of the insulating covering or the like, there is a risk that the worker will not notice even if the electric wire twists one revolution, but this can be prevented.

In a third aspect according to the second aspect, the first reference line and the second reference line may be provided in a linear shape in a view from a radially outer side of the insulating covering.

According to this configuration, the first reference line and the second reference line are provided in a linear shape in a view from the radially outer side of the insulating covering, and therefore can be easily provided. For example, the first reference line and the second reference line can be applied using a straight line jig. This makes manufacturing easy.

In a fourth aspect according to the third aspect, the first reference line and the second reference line may be provided at a position where a level difference between the first reference line and the second reference line is the smallest.

According to this configuration, the first reference line and the second reference line are provided at a position where the level difference between the first reference line and the second reference line is the smallest, and therefore can be easily provided. For example, the first reference line and the second reference line can be easily applied continuously. This makes manufacturing easier.

In a fifth aspect according to any one of the first through the fourth aspects, the first reference mark may be made of paint applied to the insulating covering, and the second reference mark may be made of paint applied to the exposed portion.

With this configuration, the first reference mark is made of paint applied to the insulating covering, and the second reference mark is made of paint applied to the exposed portion, and therefore the first reference mark and the second reference mark can be easily provided compared to, for example, a case in which they are made of adhesive tape.

A sixth aspect according to any one of the first through the fifth aspects may further include a first attachment member that includes a first attachment portion to be attached to a first attachment target, and that is fixed to the insulating covering, and a second attachment member that includes a second attachment portion to be attached to a second attachment target, and that is fixed to the exposed portion of the electric wire provided with the second reference mark.

According to this configuration, in a composite electric wire including the first attachment member and the second attachment member, twisting of an electric wire can be prevented.

A seventh aspect according to any one of the first through the sixth aspects above may further include a separator provided between the plurality of electric wires and the insulating covering.

According to this configuration, the separator is provided between the plurality of electric wires and the insulating covering, and therefore the insulating covering can be easily separated from the plurality of electric wires, for example, when the exposed portions are exposed by removing a portion of the insulating covering. Specifically, for example, in a case where the insulating covering is provided on the outside of the plurality of electric wires by extrusion molding or the like, if the separator is not provided, the insulating covering will adhere to the plurality of electric wires, making it difficult to separate them later. However, this can be avoided.

In an eighth aspect, the method for manufacturing a composite electric wire according to the present disclosure includes a first fixing step of fixing a first attachment member to an insulating covering that collectively covers a plurality of electric wires; and a second fixing step of fixing a second attachment member to an exposed portion of the plurality of electric wires exposed due to protruding outside from an end portion of the insulating covering, in which the first attachment member includes a first attachment portion to be attached to a first attachment target, the second attachment member includes a second attachment portion to be attached to a second attachment target, the method further includes: a first reference step of providing a first reference mark on a portion in a peripheral direction of the insulating covering before the first fixing step; and a second reference step of providing a second reference mark on a portion in a peripheral direction of the exposed portion before the second fixing step, in the first fixing step, the first attachment member is fixed to the insulating covering while a position in the peripheral direction of the first attachment portion is determined based on the first reference mark, and in the second fixing step, the second attachment member is fixed to the exposed portion while a position in the peripheral direction of the second attachment portion is determined based on the second reference mark.

According to this method, in the first reference step before the first fixing step, the first reference mark is provided on a portion in the peripheral direction of the insulating covering, and in the second reference step before the second fixing step, the second reference mark is provided on a portion in the peripheral direction of the exposed portion. Then, in the first fixing step, the first attachment member is fixed to the insulating covering while the position in the peripheral direction of the first attachment portion is determined based on the first reference mark. Also, in the second fixing step, the second attachment member is fixed to the exposed portion while the position in the peripheral direction of the second attachment portion is determined based on the second reference mark. This makes it possible to prevent twisting of an electric wire when the composite electric wire is attached to the first attachment target and the second attachment target.

Specific examples of the composite electric wire of the present disclosure will be described below with reference to the drawings. In each drawing, for the convenience of description, some parts of the configuration are exaggerated or simplified in some cases. In addition, the dimensional proportions of each portion differs between the drawings in some cases. In this specification, “parallel”, “orthogonal”, and “perfectly circular” do not only mean strictly parallel, orthogonal, or perfectly circular, but also include approximately parallel, orthogonal, or perfectly circular within the range in which the action and effect of this embodiment is achieved. Note that the present disclosure is not limited to these examples, but is indicated by the claims, and all modifications within the meaning and scope equivalent to the claims are intended to be encompassed therein.

### Configuration of Composite Electric Wire 11

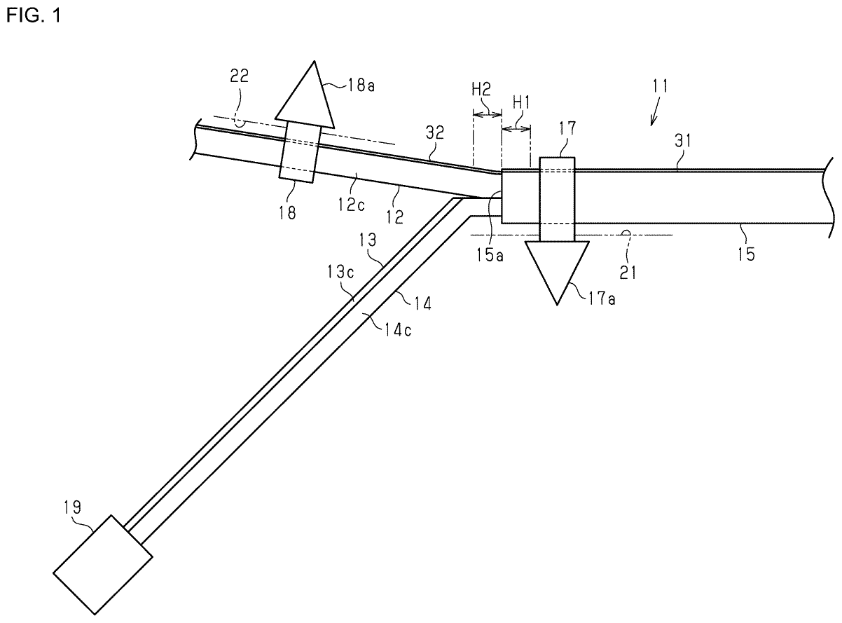

As shown in FIGS. 1 to 3, the composite electric wire 11 includes a first electric wire 12, a second electric wire 13, and a third electric wire 14 serving as a plurality of electric wires, and an insulating covering 15 that collectively covers the first electric wire 12, the second electric wire 13, and the third electric wire 14.

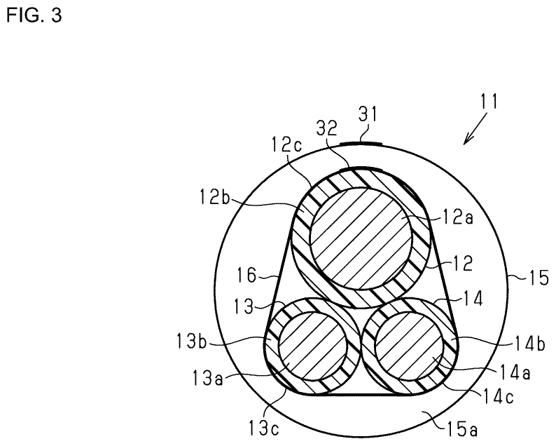

As shown in FIG. 3, the composite electric wire 11 further includes a separator 16. As shown in FIG. 1, the composite electric wire 11 includes a first attachment member 17, a second attachment member 18, and a connector 19.

### Configuration of First Electric Wire 12, Second Electric Wire 13, and Third Electric Wire 14

As shown in FIG. 3, the first electric wire 12, the second electric wire 13, and the third electric wire 14 have conductive core wires 12a, 13a, and 14a, and electric wire insulating coverings 12b, 13b, and 14b that cover the outer peripheries of the core wires 12a, 13a, and 14a and have insulating properties. Note that in this embodiment, the diameter of the first electric wire 12 is larger than the diameters of the second electric wire 13 and the third electric wire 14, and the diameters of the second electric wire 13 and the third electric wire 14 are the same.

### Configuration of Insulating Covering 15 and Separator 16

The insulating covering 15 is made of an insulating resin material. In this embodiment, the insulating covering 15 is made of polyethylene. The insulating covering 15 is provided by extrusion molding on the outside of the first electric wire 12, the second electric wire 13, and the third electric wire 14 so as to collectively cover the first electric wire 12, the second electric wire 13, and the third electric wire 14. The outer periphery of the insulating covering 15 is circular.

The separator 16 is provided between the insulating covering 15 and the first electric wire 12, the second electric wire 13, and the third electric wire 14. More specifically, the separator 16 collectively covers the first electric wire 12, the second electric wire 13, and the third electric wire 14. The separator 16 of this embodiment is made of nonwoven fabric, and is wound around the first electric wire 12, the second electric wire 13, and the third electric wire 14. The insulating covering 15 is provided on the outside of the separator 16. Note that inside the separator 16, parts where the first electric wire 12, the second electric wire 13, and the third electric wire 14 are not present are gaps. In FIG. 3, the separator 16 is schematically illustrated by a single line. In addition, each of the first electric wire 12, the second electric wire 13, and the third electric wire 14 in the part covered by the insulating covering 15 is formed into a spiral shape. In other words, the first electric wire 12, the second electric wire 13, and the third electric wire 14 at the parts covered by the insulating covering 15 are twisted together in a bundled state. That is, before the separator 16 and the insulating covering 15 are provided, the first electric wire 12, the second electric wire 13, and the third electric wire 14 are twisted together, and in this state, the separator 16 and the insulating covering 15 are provided on the outside.

As shown in FIG. 1, the first electric wire 12, the second electric wire 13 and the third electric wire 14 have exposed portions 12c, 13c, and 14c that protrude outside from an end portion 15a of the insulating covering 15 and are exposed. Note that in the present embodiment, the exposed portions 12c, 13c, and 14c are exposed by removing part of the insulating covering 15 and the separator 16. That is, the composite electric wire 11 is manufactured by first manufacturing the first electric wire 12, the second electric wire 13, and the third electric wire 14 so that their entireties in the extension direction are covered by the separator 16 and the insulating covering 15, and then removing part of the insulating covering 15 and the separator 16.

### Configuration of First Attachment Member 17 and Second Attachment Member 18

The first attachment member 17 has a first attachment portion 17a that is to be attached to a first attachment target 21, and the first attachment member 17 is fixed to the insulating covering 15. For example, the first attachment member 17 is fixed to the insulating covering 15 while covering the outer periphery of the insulating covering 15. Also, for example, the first attachment portion 17a protrudes radially outward from a portion in the peripheral direction of the insulating covering 15, and is fitted into an attachment hole of the first attachment target 21. Note that the first attachment target 21 is, for example, a body of a vehicle (not shown). As a result, the insulating covering 15 is attached to the first attachment target 21. In FIG. 1, the first attachment portion 17a is illustrated schematically as a triangle.

The second attachment member 18 has a second attachment portion 18a that is to be attached to a second attachment target 22, and the second attachment member 18 is fixed to the exposed portion 12c of the first electric wire 12. For example, the second attachment member 18 is fixed to the exposed portion 12c of the first electric wire 12 while covering the outer periphery of the exposed portion 12c. Also, for example, the second attachment portion 18a protrudes radially outward from a portion in the peripheral direction of the exposed portion 12c, and is fitted into an attachment hole of the second attachment target 22. Note that the second attachment target 22 is, for example, a body of a vehicle (not shown). As a result, the exposed portion 12c of the first electric wire 12 is attached to the second attachment target 22. In FIG. 1, the second attachment portion 18a is illustrated schematically as a triangle.

In the composite electric wire 11 of this embodiment, both ends of each of the core wires 12a, 13a, and 14a of the first electric wire 12, the second electric wire 13, and the third electric wire 14 are electrically connected to an electric device or the like. For example, one end portion of each of the core wires 13a and 14a of the second electric wire 13 and the third electric wire 14 is electrically connected to the connector 19 (see FIG. 1).

Here, as shown in FIGS. 1 to 3, a first reference line 31 serving as a first reference mark is provided at a portion in the peripheral direction of the insulating covering 15, and a second reference line 32 is provided at a portion in the peripheral direction of the exposed portion 12c of the first electric wire 12.

As shown in FIG. 1, the first reference line 31 is provided continuously from a non-twistable range H1 adjacent to the end portion 15a of the insulating covering 15 to at least the fixing location of the first attachment member 17. Note that the non-twistable range H1 referred to here is the range in which the insulating covering 15 cannot be twisted one revolution around its own axial center (e.g., this is not possible because the insulating covering 15 would be torn), and in this embodiment, the non-twistable range H1 is set to a range in which the insulating covering 15 cannot twist 0.5 revolutions. The first reference line 31 in this embodiment is provided over the entire insulating covering 15 in the extension direction.

Also, the second reference line 32 is provided continuously from a non-twistable range H2 adjacent to the end portion 15a of the insulating covering 15 to at least the fixing location of the second attachment member 18. Note that the non-twistable range H2 is a range in which the first electric wire 12 cannot twist one revolution around its own axial center (e.g., this is not possible because the electric wire insulating covering 12b would be torn), and in this embodiment, the non-twistable range H2 is set to a range in which the first electric wire 12 cannot twist 0.5 revolutions. The second reference line 32 in this embodiment is provided over the entire exposed portion 12c of the first electric wire 12 in the extension direction.

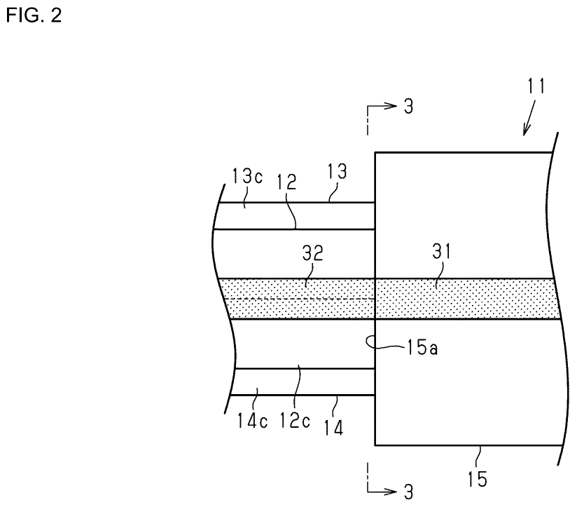

Also, as shown in FIG. 2, the first reference line 31 and the second reference line 32 are provided at positions where both are visible in a view from a radially outer side of the insulating covering 15, and more specifically, in a view from a certain direction on the radially outer side of the insulating covering 15. The first reference line 31 and the second reference line 32 are provided so as to be continuous with each other in a view from the radially outer side of the insulating covering 15. The first reference line 31 and the second reference line 32 are provided in a linear shape in a view from the radially outer side of the insulating covering 15.

As shown in FIG. 3, the first reference line 31 and the second reference line 32 are provided at a position where the level difference between the first reference line 31 and the second reference line 32 is the smallest. That is, the second reference line 32 is provided on the outer peripheral surface of the exposed portion 12c of the first electric wire 12 at the position in the peripheral direction that is the closest to the outer peripheral surface of the insulating covering 15.

The first reference line 31 is made of paint applied to the insulating covering 15, and the second reference line 32 is made of paint applied to the exposed portion 12c of the first electric wire 12. In this embodiment, the first reference line 31 and the second reference line 32 are painted with a color different from the colors of the insulating covering 15 and the exposed portion 12c, and are applied with, for example, a pen or spray.

The first attachment member 17 is fixed to the insulating covering 15 while the position in the peripheral direction of the first attachment portion 17a is determined based on the first reference line 31. In this embodiment, the first attachment member 17 is fixed to the insulating covering 15 such that the first attachment portion 17a is located on the side opposite to the first reference line 31 in the peripheral direction of the insulating covering 15, that is, at a position shifted 180° from the first reference line 31.

The second attachment member 18 is fixed to the exposed portion 12c of the first electric wire 12 while the position in the peripheral direction of the second attachment portion 18a is determined based on the second reference line 32. In this embodiment, the second attachment member 18 is fixed to the exposed portion 12c such that the second attachment portion 18a is disposed at a position that coincides with the second reference line 32 in the peripheral direction of the exposed portion 12c.

Next, a method for manufacturing the composite electric wire 11 configured as above and the function of the composite electric wire 11 will be described.

The method for manufacturing the composite electric wire 11 includes a “covering step”, a “partial covering removal step”, a “first reference step”, a “second reference step”, a “first fixing step”, and a “second fixing step”.

First, in the covering step, the separator 16 is disposed on the outer side of the first electric wire 12, second electric wire 13, and third electric wire 14 that are twisted together, and the insulating covering 15 is provided on the outer side thereof by extrusion molding.

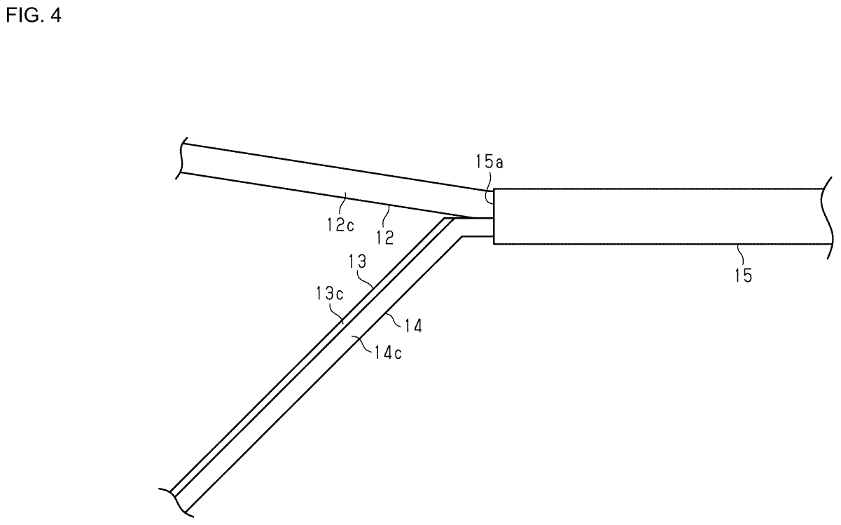

Next, as shown in FIG. 4, in the partial covering removal step, portions of the insulating covering 15 and the separator 16 are removed to cause portions of the first electric wire 12, the second electric wire 13, and the third electric wire 14 to protrude to the outside from the end portion 15a of the insulating covering 15. As a result, the first electric wire 12, the second electric wire 13, and the third electric wire 14 have the exposed portions 12c, 13c, and 14c exposed to the outer side. Note that since the first electric wire 12, the second electric wire 13, and the third electric wire 14 are twisted together inside the insulating covering 15, the position in the peripheral direction of the insulating covering 15 from which the first electric wire 12 protrudes is determined depending on which part of the insulating covering 15 is removed. Therefore, the first reference line 31 and the second reference line 32 described above cannot be provided before the partial covering removal step.

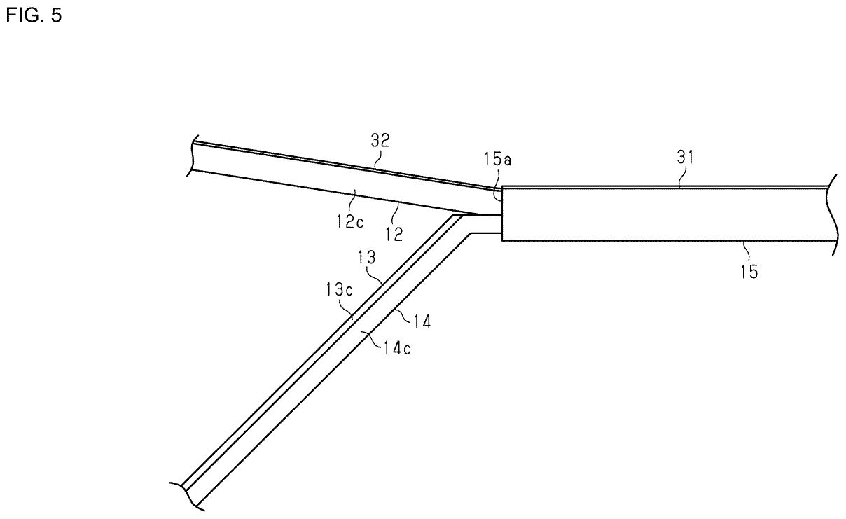

Next, as shown in FIG. 5, in the first reference step, the first reference line 31 is provided at a portion in the peripheral direction of the insulating covering 15. In the second reference step, the second reference line 32 is provided at a portion in the peripheral direction of the exposed portion 12c of the first electric wire 12. In this embodiment, the first reference step and the second reference step are performed consecutively. That is, in this embodiment, the first reference line 31 is applied to a portion in the peripheral direction of the insulating covering 15 using a pen, spray, or the like, and the second reference line 32 is consecutively applied to a portion in the peripheral direction of the exposed portion 12c.

Next, as shown in FIG. 1, in the first fixing step, the first attachment member 17 is fixed to the insulating covering 15 while the position in the peripheral direction of the first attachment portion 17a is determined based on the first reference line 31. In the second fixing step, the second attachment member 18 is fixed to the exposed portion 12c of the first electric wire 12 while the position in the peripheral direction of the second attachment portion 18a is determined based on the second reference line 32.

The composite electric wire 11 configured in this manner is attached to the first attachment target 21 and the second attachment target 22 by attaching the first attachment portion 17a to the first attachment target 21 and attaching the second attachment portion 18a to the second attachment target 22.

Next, the effects of the above embodiment will be described below.

The first reference line 31 is provided at a portion in the peripheral direction of the insulating covering 15, and the second reference line 32 is provided at a portion in the peripheral direction of the exposed portion 12c of the first electric wire 12, thereby making it possible to prevent twisting of the first electric wire 12. For example, when the first attachment member 17, which is to be fixed to the insulating covering 15 while the first attachment portion 17a is attached to the first attachment target 21, is fixed to the insulating covering 15, the position in the peripheral direction of the first attachment portion 17a is determined based on the first reference line 31. Then, when the second attachment member 18, which is to be fixed to the exposed portion 12c of the first electric wire 12 while the second attachment portion 18a is attached to the second attachment target 22, is fixed to the exposed portion 12c, the position in the peripheral direction of the second attachment portion 18a is determined based on the second reference line 32. This makes it possible to prevent twisting of the first electric wire 12 when the composite electric wire 11 is attached to the first attachment target 21 and the second attachment target 22. In addition, since the composite electric wire 11 is attached to the first attachment target 21 and the second attachment target 22 based on the first reference line 31 of the insulating covering 15 and the second reference line 32 of the first electric wire 12, the positions of the second electric wire 13 and the third electric wire 14 can also be set to favorable positions. Specifically, first, for example, as shown in FIG. 3, the first reference line 31 and the second reference line 32 are provided (upper part of FIG. 3), and then the positions of the second electric wire 13 and the third electric wire 14 relative to the first reference line 31 and the second reference line 32 are determined (lower part of FIG. 3). Then, since the composite electric wire 11 is attached to the first attachment target 21 and the second attachment target 22 based on the first reference line 31 and the second reference line 32, the positions of the second electric wire 13 and the third electric wire 14 relative to the first attachment target 21 and the second attachment target 22 are also determined. This can also suppress problems such as the second electric wire 13 and the third electric wire 14 colliding with other members.

The first reference mark is the first reference line 31 that is continuous from the non-twistable range H1 adjacent to the end portion 15a of the insulating covering 15 to the fixing location of the first attachment member 17. The second reference mark is a second reference line 32 that is continuous from the non-twistable range H2 adjacent to the end portion 15a of the insulating covering 15 to the fixing location of the second attachment member 18. As a result, for example, the first electric wire 12 is prevented from twisting one revolution. That is, for example, if the second reference mark is provided at only the fixing location of the second attachment member 18 and that fixing location is far from the end portion 15a of the insulating covering 15, there is a risk that the worker will not notice even if the first electric wire 12 is twisted one revolution. However, this can be prevented.

The first reference line 31 and the second reference line 32 are provided in a linear shape in a view from the radially outer side of the insulating covering 15, and therefore can be easily provided. For example, the first reference line 31 and the second reference line 32 can be painted using a straight line jig. This makes manufacturing easy. In addition, the first reference line 31 and the second reference line 32 are provided at positions where both are visible in a view from a certain direction on the radially outer side of the insulating covering 15. As a result, for example, a worker can simultaneously view the first reference line 31 and the second reference line 32, which consequently improves workability when fixing the first attachment member 17 and the second attachment member 18, for example.

The first reference line 31 and the second reference line 32 are provided at a position where the level difference between the first reference line 31 and the second reference line 32 is the smallest, and therefore can be easily provided. For example, the first reference line 31 and the second reference line 32 can be easily painted continuously. This makes manufacturing easier.

Since the first reference line 31 is made of paint applied to the insulating covering 15, and the second reference line 32 is made of paint applied to the exposed portion 12c of the first electric wire 12, they can be easily provided compared to, for example, a case where they are made of adhesive tape.

The separator 16 is provided between the insulating covering 15 and the first electric wire 12, the second electric wire 13, and the third electric wire 14. As a result, for example, when removing a portion of the insulating covering 15 to expose the exposed portions 12c, 13c, and 14c, the insulating covering 15 can be easily separated from the first electric wire 12, the second electric wire 13, and the third electric wire 14. Specifically, for example, in the case where the insulating covering 15 is provided on the outer side of the first electric wire 12, the second electric wire 13, and the third electric wire 14 by extrusion molding, if the separator 16 is not included, the insulating covering 15 adheres to the first electric wire 12, the second electric wire 13, and the third electric wire 14 in some cases. In this case, it is difficult to separate the insulating covering 15 from the first electric wire 12, the second electric wire 13, and the third electric wire 14 later. However, this can be avoided. As a result, for example, manufacturing is easy.

In the method for manufacturing the composite electric wire 11, in the first reference step before the first fixing step, the first reference line 31 is provided at a portion in the peripheral direction of the insulating covering 15, and in the second reference step before the second fixing step, the second reference line 32 is provided at a portion in the peripheral direction of the exposed portion 12c. Then, in the first fixing step, the first attachment member 17 is fixed to the insulating covering 15 while the position in the peripheral direction of the first attachment portion 17a is determined based on the first reference line 31. In addition, in the second fixing step, the position in the peripheral direction of the second attachment portion 18a is determined based on the second reference line 32, and the second attachment member 18 is fixed to the exposed portion 12c. This makes it possible to prevent twisting of the first electric wire 12 when the composite electric wire 11 is attached to the first attachment target 21 and the second attachment target 22.

This embodiment can be modified and implemented as follows. The present embodiment and the following modified examples can be implemented in combination with each other as long as no technical contradiction occurs.

In the above embodiment, the first reference mark is the first reference line 31 and the second reference mark is the second reference line 32, but there is no limitation to this. For example, the first reference line 31 may be a first reference mark provided at only the fixing location of the first attachment member 17. In addition, the second reference line 32 may be a second reference mark provided at only the fixing location of the second attachment member 18.

In the above embodiment, the first reference line 31 is provided over the entire insulating covering 15 in the extension direction and extends from the end portion 15a of the insulating covering 15, but there is no limitation to this. For example, the first reference line 31 may be provided continuously from a position spaced apart from the end portion 15a of the insulating covering 15 within the non-twistable range H1 adjacent to the end portion 15a of the insulating covering 15, to the fixing location of the first attachment member 17. In the above embodiment, the second reference line 32 is provided over the entire exposed portion 12c of the first electric wire 12 in the extension direction and extends from the end portion 15a of the insulating covering 15, but there is no limitation to this. For example, the second reference line 32 may be provided continuously from a position spaced apart from the end portion 15a of the insulating covering 15 within the non-twistable range H2 adjacent to the end portion 15a of the insulating covering 15, to the fixing location of the second attachment member 18. Even in this case, the same effect as effect (2) of the above embodiment can be obtained.

In the above embodiment, the first reference line 31 and the second reference line 32 are arranged in a linear shape in a view from the radially outer side of the insulating covering 15, but there is no limitation to this. The first reference line 31 and the second reference line 32 may be deviated from a linear shape in a view from the radially outer side of the insulating covering 15. Note that even in this case, it is preferable that the first reference line 31 and the second reference line 32 are provided at positions where both are visible in a view from a certain direction on the radially outer side of the insulating covering 15.

In the above embodiment, the first reference line 31 and the second reference line 32 are provided at a position where the level difference between the first reference line 31 and the second reference line 32 is the smallest, but there is no limitation to this. The lines may be provided at a position where the level difference is large.

In the above embodiment, the first reference line 31 is made of paint applied to the insulating covering 15, and the second reference line 32 is made of paint applied to the exposed portion 12c, but there is no limitation to this. The first reference line 31 and the second reference line 32 may also be made of, for example, adhesive tape.

In the above embodiment, the separator 16 is provided between the insulating covering 15 and the first electric wire 12, the second electric wire 13, and the third electric wire 14, but there is no limitation to this. A configuration is also possible in which the separator 16 is not included. Also, in the above embodiment, the separator 16 is made of nonwoven fabric, but there is no limitation to this. The separator 16 may also be changed to another separator 16 such as one made of paper or powder.

The first reference line 31 and the second reference line 32 in the above embodiment are not limited to solid lines, and may be other types of lines such as dashed lines. That is, the first reference line 31 and the second reference line 32 may be changed to other types of lines, such as dashed lines.

In the above embodiment, the composite electric wire 11 includes a plurality of electric wires, that is, the first electric wire 12, the second electric wire 13, and the third electric wire 14. However, the composite electric wire 11 may also include two electric wires or four or more electric wires, such as six or eight electric wires. In addition, the thicknesses of the plurality of electric wires included in the composite electric wire 11 may all be the same or some may be different.

In the above embodiment, the second attachment member 18 is fixed to the exposed portion 12c of the first electric wire 12, but there is no limitation to this. The second attachment member 18 may also be fixed to the exposed portion 13c of the second electric wire 13 or the exposed portion 14c of the third electric wire 14. In such a case, the second reference line may be provided on the exposed portion 13c of the second electric wire 13 or the exposed portion 14c of the third electric wire 14.

What is claimed is:

1. A composite electric wire comprising:
a plurality of electric wires; and
an insulating covering that collectively covers the plurality of electric wires,
wherein the plurality of electric wires include exposed portions that are exposed by protruding outside from an end portion of the insulating covering,
a first reference mark is provided at a portion in a peripheral direction of the insulating covering, and
a second reference mark is provided at a portion in a peripheral direction of the exposed portion of one of the plurality of electric wires.

2. The composite electric wire according to claim 1,
wherein a first attachment member is fixed to the insulating covering and the insulating covering is attached to a first attachment target by a first attachment portion of the first attachment member,
a second attachment member is fixed to the exposed portion of the electric wire provided with the second reference mark and the exposed portion is attached to a second attachment target by a second attachment portion of the second attachment member,
the first reference mark is a first reference line provided continuously from a non-twistable range adjacent to the end portion of the insulating covering, to a fixing location of the first attachment member, and
the second reference mark is a second reference line provided continuously from a non-twistable range adjacent to the end portion of the insulating covering, to a fixing location of the second attachment member.

3. The composite electric wire according to claim 2,
wherein the first reference line and the second reference line are provided in a linear shape in a view from a radially outer side of the insulating covering.

4. The composite electric wire according to claim 3,
wherein the first reference line and the second reference line are provided at a position where a level difference between the first reference line and the second reference line is the smallest.

5. The composite electric wire according to claim 1,
wherein the first reference mark is made of paint applied to the insulating covering, and
the second reference mark is made of paint applied to the exposed portion.

6. The composite electric wire according to claim 1, further comprising:
a first attachment member that includes a first attachment portion to be attached to a first attachment target, and that is fixed to the insulating covering; and
a second attachment member that includes a second attachment portion to be attached to a second attachment target, and that is fixed to the exposed portion of the electric wire provided with the second reference mark.

7. The composite electric wire according to claim 1, further comprising
a separator provided between the plurality of electric wires and the insulating covering.

8. A method for manufacturing a composite electric wire, comprising:
a first fixing step of fixing a first attachment member to an insulating covering that collectively covers a plurality of electric wires; and
a second fixing step of fixing a second attachment member to an exposed portion of the plurality of electric wires exposed due to protruding outside from an end portion of the insulating covering,
wherein the first attachment member includes a first attachment portion to be attached to a first attachment target,
the second attachment member includes a second attachment portion to be attached to a second attachment target,
the method further comprises:
a first reference step of providing a first reference mark on a portion in a peripheral direction of the insulating covering before the first fixing step; and
a second reference step of providing a second reference mark on a portion in a peripheral direction of the exposed portion before the second fixing step,
in the first fixing step, the first attachment member is fixed to the insulating covering while a position in the peripheral direction of the first attachment portion is determined based on the first reference mark, and
in the second fixing step, the second attachment member is fixed to the exposed portion while a position in the peripheral direction of the second attachment portion is determined based on the second reference mark.
